(19) United States
(12) Patent Application Publication
(10) Pub. No.: US 2011/0270904 A1
(43) Pub. Date: Nov. 3, 2011

(54) Systems And Methods For Estimating A Wavelet Transform With A Goertzel Technique

(75) Inventor: Braddon M. Van Slyke, Arvada, CO (US)

(73) Assignee: Nellcor Puritan Bennett LLC, Boulder, CO (US)

(21) Appl. No.: 12/771,862

(22) Filed: Apr. 30, 2010

(51) Int. Cl. G06F 17/14

(52) U.S. Cl. 708/400

(57) ABSTRACT

Systems and methods for processing a signal by estimating a wavelet transform of the signal using at least one scale that is associated with at least one data sample are provided. The systems and methods employ a Goertzel technique to estimate the wavelet transform without using any convolution operations.

### SUMMARY

The present disclosure relates to signal processing and, more particularly, the present disclosure relates to using continuous wavelet transforms for processing, for example, a photoplethysmograph (PPG) signal. In particular, the present disclosure provides systems and methods for processing a signal by estimating a wavelet transform of the signal using at least one scale that is associated with at least one data sample. The systems and methods employ a Goertzel technique to estimate the wavelet transform.

In some embodiments, a magnitude value for each sample in each of at least one scale is generated. The magnitude value is generated based at least in part on a Goertzel technique. The magnitude values estimate a wavelet transform. The generated magnitude values are stored in an electronic storage device (e.g., a memory).

In some embodiments, the magnitude value for each sample may be generated by first initializing a predetermined coefficient value and temporary storage values for each scale. In some implementations, the predetermined coefficient value may be computed as a multiple of the cosine function of a value corresponding to the number of scales, a sample rate of a scale, and a target frequency value for the scale. For each of the data samples in each of the scales a recursion value is computed based on a first function of (a) the temporary storage values corresponding to the data samples in each of the scales, (b) the predetermined coefficient value and (c) the corresponding data samples in each of the scales. In particular, the first function may be computed by multiplying the coefficient value of a given scale by a first of the temporary values and computing the difference between that operation and the sum of a second of the temporary values and the value of the given sample.

The first and second temporary storage values may be updated based on the computed recursion value. In particular, the second temporary storage value may equated to the value of the first temporary storage value and the first temporary storage value may be equated to the recursion value. A magnitude value may be computed based on the values of the temporary storage values and the recursion value and the process may be repeated to compute the magnitude values for each of the remaining samples in each scale.

In some embodiments, the magnitude values for each of the samples in each of the scales may be computed in parallel. In particular, a set of coefficient values may be computed for each scale. The set of coefficient values may be used to compute the magnitude values of the samples in each scale in parallel. In some implementations, one magnitude value for one sample in each scale is output at a time (e.g., each clock cycle). The magnitude values that are generated for each of the samples in each of the scales may estimate the Wavelet transform. The magnitude values that estimate the Wavelet transform using the Goertzel technique may be computed without any convolution operations.

In some embodiments, the generated magnitude values may be processed to remove any skew in time (e.g., using a de-skewing technique), In some implementations, the data samples may be preprocessed by windowing the samples to change the width of the filter response (e.g., represented by the magnitude values). In particular, the samples may be multiplied by a predefined set of values that represent a Gaussian window or a Hamming window based on the type of wavelet that is to be estimated,

It may be a recursive algorithm and may require only a few multiplications, additions, subtractions and intermediate value updates. Its filter response has a shape close to that of a Gaussian envelope. Complex Morlet wavelets, often used in wavelet transforms have an energy density that also follows a Gaussian envelope. As an alternative to using a wavelet table containing various wavelets coefficients, and convolving an input signal with the wavelet table to produce a scalogram, a Goertzel technique may be used for each scale. The Goertzel technique can produce both complex outputs, as does a Complex Morlet wavelet transform. A simplified version of the Goertzel technique can produce only a magnitude squared value if phase is not needed. The magnitude squared value may correspond with a Gaussian envelope and so a square root function may be avoided as it may not be needed.

An illustrative Goertzel technique for estimating a wavelet transform is shown below:

// At start , pre-compute coefficients

| | |
|---|---|
| k = (int) (0.5 + N * target_freq / sample_rate) | // pre-computed |

coefficients

w = 2 * n / N * k
cosine = cos(w)
sine = sin(w)
coeff = 2 * cosine
Q1 = 0; Q2 = 0
for each scale

| for each sample | |
|---|---|
| Q0 = coeff * Q1 − Q2 + sample | |
| Q2 = Q1 | // save these for next iteration |

Q1 = Q0
magnitude_sq = Q1 * Q1 +Q2 * Q2 − Q1 * Q2 * coeff

end

For each scale, separate coefficients and recursive storage are kept. The width of the filter response can be changed by “windowing” the input data, that is, multiplying the input data by a set of pre-defined values. Windows that may be used include Hamming and Hanning windows. Another window that may be used is a Gaussian window. Being able to change the shape of the filter response may be desirable in order to mimic the response of the wavelet coefficients.

A scalogram may include previously calculated magnitude values. As a new magnitude value is calculated, the values in the scalogram are shifted in time to make room for the new magnitude values. If a complex scalogram is needed for phase estimation purposes, the previously detailed technique can be modified to produce real and imaginary magnitude values. If the resulting magnitude values are “skewed” in time, de-skewing techniques may be employed.

The described technique may be implemented in a fixed or floating point format. Other suitable modifications to the Goertzel technique may be made so that the output is similar to that of a typical continuous wavelet transform and may depend upon the type of wavelet used, be it a Complex Morlet, Mexican Hat, or other typical or suitable wavelet.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows an illustrative pulse oximetry system in accordance with an embodiment;

FIG. 2 is a block diagram of the illustrative pulse oximetry system of FIG. 1 coupled to a patient in accordance with an embodiment;

FIGS. 3(a) and 3(b) show illustrative views of a scalogram derived from a PPG signal in accordance with an embodiment;

FIG. 3(c) shows an illustrative scalogram derived from a signal containing two pertinent components in accordance with an embodiment;

FIG. 3(d) shows an illustrative schematic of signals associated with a ridge in FIG. 3(c) and illustrative schematics of a further wavelet decomposition of these newly derived signals in accordance with an embodiment;

FIGS. 3(e) and 3(f) are flow charts of illustrative steps involved in performing an inverse continuous wavelet transform in accordance with embodiments;

FIG. 4 is a block diagram of an illustrative continuous wavelet processing system in accordance with some embodiments;

FIG. 5 shows an illustrative flow diagram for employing the Goertzel technique on a received signal in accordance with an embodiment;

FIG. 6 shows an illustrative flow diagram for estimating the wavelet transform using the Goertzel technique in accordance with an embodiment; and

FIG. 7 is a block diagram of a system implementing the Goertzel technique in parallel in accordance with an embodiment.

### DETAILED DESCRIPTION

An oximeter is a medical device that may determine the oxygen saturation of the blood. One common type of oximeter is a pulse oximeter, which may indirectly measure the oxygen saturation of a patient's blood (as opposed to measuring oxygen saturation directly by analyzing a blood sample taken from the patient) and changes in blood volume in the skin. Ancillary to the blood oxygen saturation measurement, pulse oximeters may also be used to measure the pulse rate of the patient. Pulse oximeters typically measure and display various blood flow characteristics including, but not limited to, the oxygen saturation of hemoglobin in arterial blood.

An oximeter may include a light sensor that is placed at a site on a patient, typically a fingertip, toe, forehead or earlobe, or in the case of a neonate, across a foot. The oximeter may pass light using a light source through blood perfused tissue and photoelectrically sense the absorption of light in the tissue. For example, the oximeter may measure the intensity of light that is received at the light sensor as a function of time. A signal representing light intensity versus time or a mathematical manipulation of this signal (e.g., a scaled version thereof, a log taken thereof, a scaled version of a log taken thereof, etc.) may be referred to as the photoplethysmograph (PPG) signal. In addition, the term “PPG signal,” as used herein, may also refer to an absorption signal (i.e., representing the amount of light absorbed by the tissue) or any suitable mathematical manipulation thereof. The light intensity or the amount of light absorbed may then be used to calculate the amount of the blood constituent (e.g., oxyhemoglobin) being measured as well as the pulse rate and when each individual pulse occurs.

The light passed through the tissue is selected to be of one or more wavelengths that are absorbed by the blood in an amount representative of the amount of the blood constituent present in the blood. The amount of light passed through the tissue varies in accordance with the changing amount of blood constituent in the tissue and the related light absorption. Red and infrared wavelengths may be used because it has been observed that highly oxygenated blood will absorb relatively less red light and more infrared light than blood with a lower oxygen saturation. By comparing the intensities of two wavelengths at different points in the pulse cycle, it is possible to estimate the blood oxygen saturation of hemoglobin in arterial blood.

When the measured blood parameter is the oxygen saturation of hemoglobin, a convenient starting point assumes a saturation calculation based on Lambert-Beer's law. The following notation will be used herein:

I(λ, t)=Iₒ(λ)exp(−(sβₒ(λ)+(1−s)βᵣ(λ))l(t)) (1)

where:
λ=wavelength;
t=time;
I=intensity of light detected;
Iₒ=intensity of light transmitted;
s=oxygen saturation;
βₒ, βᵣ=empirically derived absorption coefficients; and
l(t)=a combination of concentration and path length from emitter to detector as a function of time.

The traditional approach measures light absorption at two wavelengths (e.g., red and infrared (IR)), and then calculates saturation by solving for the “ratio of ratios” as follows.
1. First, the natural logarithm of (1) is taken (“log” will be used to represent the natural logarithm) for IR and Red

logI=log Iₒ−(sβₒ+(1−s)βᵣ)l (2)
2. (2) is then differentiated with respect to time

$$\frac{d log I}{d t} = - ( s {β}_{o} + ( 1 - s ) {β}_{r} ) \frac{d l}{d t} \qquad ( 3 )$$

3. Red (3) is divided by IR (3)

$$\frac{d log I ( {λ}_{R} ) / d t}{d log I ( {λ}_{IR} ) / d t} = \frac{s {β}_{O} ( {λ}_{R} ) + ( 1 - s ) {β}_{r} ( {λ}_{R} )}{s {β}_{O} ( {λ}_{IR} ) + ( 1 - s ) {β}_{r} ( {λ}_{IR} )} \qquad ( 4 )$$

4. Solving for s

$$s = \frac{\frac{d log I ( {λ}_{IR} )}{d t} {β}_{r} ( {λ}_{R} ) - \frac{d log I ( {λ}_{R} )}{d t} {β}_{r} ( {λ}_{IR} )}{\begin{matrix}\frac{d log I ( {λ}_{R} )}{d t} ( {β}_{O} ( {λ}_{IR} ) - {β}_{r} ( {λ}_{IR} ) ) - \\ \frac{d log I ( {λ}_{IR} )}{d t} ( {β}_{O} ( {λ}_{R} ) - {β}_{r} ( {λ}_{R} ) )\end{matrix}}$$

Note in discrete time

$$\frac{d log I ( λ , t )}{d t} ≃ log I ( λ , {t}_{2} ) - log I ( λ , {t}_{1} )$$

### Using log A-log B=log A/B,

$$\frac{d log I ( λ , t )}{d t} ≃ log ( \frac{I ( {t}_{2} , λ )}{I ( {t}_{1} , λ )} )$$

So, (4) can be rewritten as

$$\frac{\frac{d log I ( {λ}_{R} )}{d t}}{\frac{d log I ( {λ}_{IR} )}{d t}} ≃ \frac{log ( \frac{I ( {t}_{1} , {λ}_{R} )}{I ( {t}_{2} , {λ}_{R} )} )}{log ( \frac{I ( {t}_{1} , {λ}_{IR} )}{I ( {t}_{2} , {λ}_{IR} )} )} = R \qquad ( 5 )$$

where R represents the “ratio of ratios.” Solving (4) for s using (5) gives

$$s = \frac{{β}_{r} ( {λ}_{R} ) - R {β}_{r} ( {λ}_{IR} )}{R ( {β}_{O} ( {λ}_{IR} ) - {β}_{r} ( {λ}_{IR} ) ) - {β}_{O} ( {λ}_{R} ) + {β}_{r} ( {λ}_{R} )} .$$

From (5), R can be calculated using two points (e.g., PPG maximum and minimum), or a family of points. One method using a family of points uses a modified version of (5). Using the relationship

$$\frac{d log I}{d t} = \frac{d I / d t}{I} \qquad ( 6 )$$

now (5) becomes

$$\begin{matrix}\frac{\frac{d log I ( {λ}_{R} )}{d t}}{\frac{d log I ( {λ}_{IR} )}{d t}} ≃ \frac{\frac{I ( {t}_{2} , {λ}_{R} ) - I ( {t}_{1} , {λ}_{R} )}{I ( {t}_{1} , {λ}_{R} )}}{\frac{I ( {t}_{2} , {λ}_{IR} ) - I ( {t}_{1} , {λ}_{IR} )}{I ( {t}_{1} , {λ}_{IR} )}} \\ = \frac{[ I ( {t}_{2} , {λ}_{R} ) - I ( {t}_{1} , {λ}_{R} ) ] I ( {t}_{1} , {λ}_{IR} )}{[ I ( {t}_{2} , {λ}_{IR} ) - I ( {t}_{1} , {λ}_{IR} ) ] I ( {t}_{1} , {λ}_{R} )} \\ = R\end{matrix} \qquad ( 7 )$$

which defines a cluster of points whose slope of y versus x will give R where

x(t)=[I(t₂,λ_{IR})−I(t₁,λ_{IR})]I(t₁,λ_{R})

y(t)=[I(t₂,λ_{R})−I(t₁,λ_{R})]I(t₁,λ_{IR})

y(t)=Rx(t) (8)

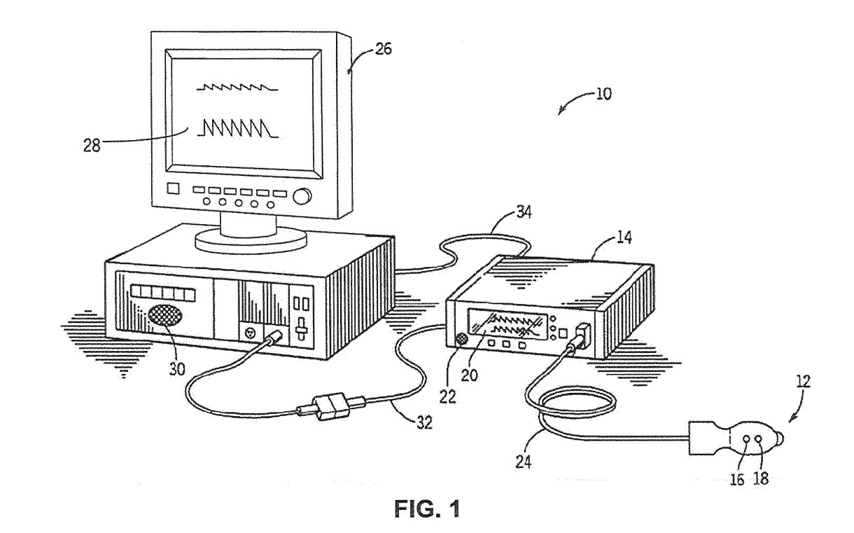

FIG. 1 is a perspective view of an embodiment of a pulse oximetry system 10. System 10 may include a sensor 12 and a pulse oximetry monitor 14. Sensor 12 may include an emitter 16 for emitting light at two or more wavelengths into a patient's tissue. A detector 18 may also be provided in sensor 12 for detecting the light originally from emitter 16 that emanates from the patient's tissue after passing through the tissue.

According to another embodiment and as will be described, system 10 may include a plurality of sensors forming a sensor array in lieu of single sensor 12. Each of the sensors of the sensor array may be a complementary metal oxide semiconductor (CMOS) sensor. Alternatively, each sensor of the array may be charged coupled device (CCD) sensor. In another embodiment, the sensor array may be made up of a combination of CMOS and CCD sensors. The CCD sensor may comprise a photoactive region and a transmission region for receiving and transmitting data whereas the CMOS sensor may be made up of an integrated circuit having an array of pixel sensors. Each pixel may have a photodetector and an active amplifier.

According to an embodiment, emitter 16 and detector 18 may be on opposite sides of a digit such as a finger or toe, in which case the light that is emanating from the tissue has passed completely through the digit. In an embodiment, emitter 16 and detector 18 may be arranged so that light from emitter 16 penetrates the tissue and is reflected by the tissue into detector 18, such as a sensor designed to obtain pulse oximetry data from a patient's forehead.

In an embodiment, the sensor or sensor array may be connected to and draw its power from monitor 14 as shown. In another embodiment, the sensor may be wirelessly connected to monitor 14 and include its own battery or similar power supply (not shown). Monitor 14 may be configured to calculate physiological parameters based at least in part on data received from sensor 12 relating to light emission and detection. In an alternative embodiment, the calculations may be performed on the monitoring device itself and the result of the oximetry reading may be passed to monitor 14. Further, monitor 14 may include a display 20 configured to display the physiological parameters or other information about the system. In the embodiment shown, monitor 14 may also include a speaker 22 to provide an audible sound that may be used in various other embodiments, such as for example, sounding an audible alarm in the event that a patient's physiological parameters are not within a predefined normal range.

In an embodiment, sensor 12, or the sensor array, may be communicatively coupled to monitor 14 via a cable 24. However, in other embodiments, a wireless transmission device (not shown) or the like may be used instead of or in addition to cable 24.

In the illustrated embodiment, pulse oximetry system 10 may also include a multi-parameter patient monitor 26. The monitor may be cathode ray tube type, a flat panel display (as shown) such as a liquid crystal display (LCD) or a plasma display, or any other type of monitor now known or later developed. Multi-parameter patient monitor 26 may be configured to calculate physiological parameters and to provide a display 28 for information from monitor 14 and from other medical monitoring devices or systems (not shown). For example, multiparameter patient monitor 26 may be configured to display an estimate of a patient's blood oxygen saturation generated by pulse oximetry monitor 14 (referred to as an “SpO₂” measurement), pulse rate information from monitor 14 and blood pressure from a blood pressure monitor (not shown) on display 28.

Monitor 14 may be communicatively coupled to multi-parameter patient monitor 26 via a cable 32 or 34 that is coupled to a sensor input port or a digital communications port, respectively and/or may communicate wirelessly (not shown). In addition, monitor 14 and/or multi-parameter patient monitor 26 may be coupled to a network to enable the sharing of information with servers or other workstations (not shown). Monitor 14 may be powered by a battery (not shown) or by a conventional power source such as a wall outlet.

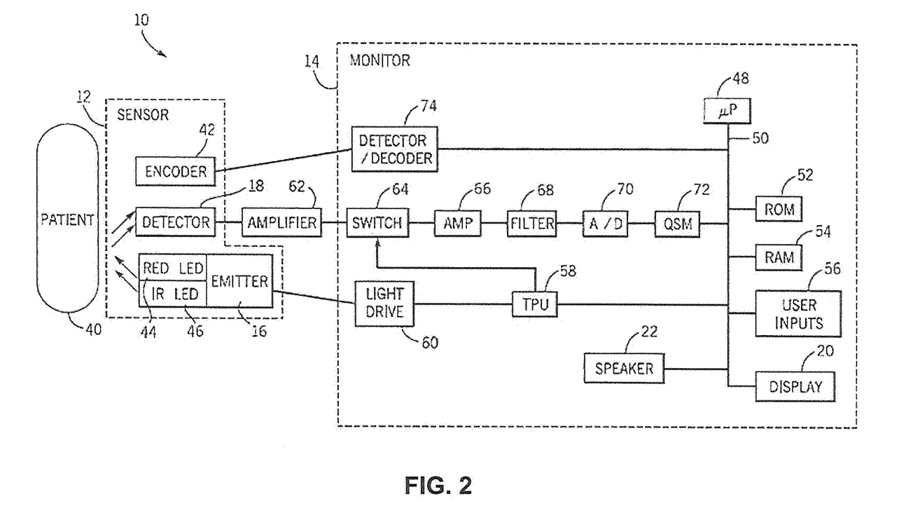

FIG. 2 is a block diagram of a pulse oximetry system, such as pulse oximetry system 10 of FIG. 1, which may be coupled to a patient 40 in accordance with an embodiment. Certain illustrative components of sensor 12 and monitor 14 are illustrated in FIG, 2. Sensor 12 may include emitter 16, detector 18, and encoder 42. In the embodiment shown, emitter 16 may be configured to emit at least two wavelengths of light (e.g., RED and IR) into a patient's tissue 40. Hence, emitter 16 may include a RED light emitting light source such as RED light emitting diode (LED) 44 and an IR light emitting light source such as IR LED 46 for emitting light into the patient's tissue 40 at the wavelengths used to calculate the patient's physiological parameters. In one embodiment, the RED wavelength may be between about 600 nm and about 700 nm, and the IR wavelength may be between about 800 nm and about 1000 nm. In embodiments where a sensor array is used in place of single sensor, each sensor may be configured to emit a single wavelength. For example, a first sensor emits only a RED light while a second only emits an IR light.

It will be understood that, as used herein, the term “light” may refer to energy produced by radiative sources and may include one or more of ultrasound, radio, microwave, millimeter wave, infrared, visible, ultraviolet, gamma ray or X-ray electromagnetic radiation. As used herein, light may also include any wavelength within the radio, microwave, infrared, visible, ultraviolet, or X-ray spectra, and that any suitable wavelength of electromagnetic radiation may be appropriate for use with the present techniques. Detector 18 may be chosen to be specifically sensitive to the chosen targeted energy spectrum of the emitter 16.

In an embodiment, detector 18 may be configured to detect the intensity of light at the RED and IR wavelengths. Alternatively, each sensor in the array may be configured to detect an intensity of a single wavelength. In operation, light may enter detector 18 after passing through the patient's tissue 40. Detector 18 may convert the intensity of the received light into an electrical signal. The light intensity is directly related to the absorbance and/or reflectance of light in the tissue 40. That is, when more light at a certain wavelength is absorbed or reflected, less light of that wavelength is received from the tissue by the detector 18. After converting the received light to an electrical signal, detector 18 may send the signal to monitor 14, where physiological parameters may be calculated based on the absorption of the RED and IR wavelengths in the patient's tissue 40.

In an embodiment, encoder 42 may contain information about sensor 12, such as what type of sensor it is (e.g., whether the sensor is intended for placement on a forehead or digit) and the wavelengths of light emitted by emitter 16. This information may be used by monitor 14 to select appropriate algorithms, lookup tables and/or calibration coefficients stored in monitor 14 for calculating the patient's physiological parameters.

Encoder 42 may contain information specific to patient 40, such as, for example, the patient's age, weight, and diagnosis. This information may allow monitor 14 to determine, for example, patient-specific threshold ranges in which the patient's physiological parameter measurements should fall and to enable or disable additional physiological parameter algorithms. Encoder 42 may, for instance, be a coded resistor which stores values corresponding to the type of sensor 12 or the type of each sensor in the sensor array, the wavelengths of light emitted by emitter 16 on each sensor of the sensor array, and/or the patient's characteristics. In another embodiment, encoder 42 may include a memory on which one or more of the following information may be stored for communication to monitor 14: the type of the sensor 12; the wavelengths of light emitted by emitter 16; the particular wavelength each sensor in the sensor array is monitoring; a signal threshold for each sensor in the sensor array; any other suitable information; or any combination thereof.

In an embodiment, signals from detector 18 and encoder 42 may be transmitted to monitor 14. In the embodiment shown, monitor 14 may include a general-purpose microprocessor 48 connected to an internal bus 50. Microprocessor 48 may be adapted to execute software, which may include an operating system and one or more applications, as part of performing the functions described herein. Also connected to bus 50 may be a read-only memory (ROM) 52, a random access memory (RAM) 54, user inputs 56, display 20, and speaker 22.

RAM 54 and ROM 52 are illustrated by way of example, and not limitation. Any suitable computer-readable media may be used in the system for data storage. Computer-readable media are capable of storing information that can be interpreted by microprocessor 48. This information may be data or may take the form of computer-executable instructions, such as software applications, that cause the microprocessor to perform certain functions and/or computer-implemented methods. Depending on the embodiment, such computer-readable media may include computer storage media and communication media. Computer storage media may include volatile and non-volatile, removable and non-removable media implemented in any method or technology for storage of information such as computer-readable instructions, data structures, program modules or other data. Computer storage media may include, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by components of the system.

In the embodiment shown, a time processing unit (TPU) 58 may provide timing control signals to a light drive circuitry 60, which may control when emitter 16 is illuminated and multiplexed timing for the RED LED 44 and the IR LED 46. TPU 58 may also control the gating-in of signals from detector 18 through an amplifier 62 and a switching circuit 64. These signals are sampled at the proper time, depending upon which light source is illuminated. The received signal from detector 18 may be passed through an amplifier 66, a low pass filter 68, and an analog-to-digital converter 70. The digital data may then be stored in a queued serial module (QSM) 72 (or buffer) for later downloading to RAM 54 as QSM 72 fills up. In one embodiment, there may be multiple separate parallel paths having amplifier 66, filter 68, and A/D converter 70 for multiple light wavelengths or spectra received.

In an embodiment, microprocessor 48 may determine the patient's physiological parameters, such as SpO₂ and pulse rate, using various algorithms and/or look-up tables based on the value of the received signals and/or data corresponding to the light received by detector 18. Signals corresponding to information about patient 40, and particularly about the intensity of light emanating from a patient's tissue over time, may be transmitted from encoder 42 to a decoder 74. These signals may include, for example, encoded information relating to patient characteristics. Decoder 74 may translate these signals to enable the microprocessor to determine the thresholds based on algorithms or look-up tables stored in ROM 52. User inputs 56 may be used to enter information about the patient, such as age, weight, height, diagnosis, medications, treatments, and so forth. In an embodiment, display 20 may exhibit a list of values which may generally apply to the patient, such as, for example, age ranges or medication families, which the user may select using user inputs 56.

The optical signal through the tissue can be degraded by noise, among other sources. One source of noise is ambient light that reaches the light detector. Another source of noise is electromagnetic coupling from other electronic instruments. Movement of the patient also introduces noise and affects the signal. For example, the contact between the detector and the skin, or the emitter and the skin, can be temporarily disrupted when movement causes either to move away from the skin. In addition, because blood is a fluid, it responds differently than the surrounding tissue to inertial effects, thus resulting in momentary changes in volume at the point to which the oximeter probe is attached.

Noise (e.g., from patient movement) can degrade a pulse oximetry signal relied upon by a physician, without the physician's awareness. This is especially true if the monitoring of the patient is remote, the motion is too small to be observed, or the doctor is watching the instrument or other parts of the patient, and not the sensor site. Processing pulse oximetry (i.e., PPG) signals may involve operations that reduce the amount of noise present in the signals or otherwise identify noise components in order to prevent them from affecting measurements of physiological parameters derived from the PPG signals.

It will be understood that the present disclosure is applicable to any suitable signals and that PPG signals are used merely for illustrative purposes. Those skilled in the art will recognize that the present disclosure has wide applicability to other signals including, but not limited to other biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In one embodiment, a PPG signal may be transformed using a continuous wavelet transform. Information derived from the transform of the PPG signal (i.e., in wavelet space) may be used to provide measurements of one or more physiological parameters.

The continuous wavelet transform of a signal x(t) in accordance with the present disclosure may be defined as

$$T ( a , b ) = \frac{1}{\sqrt{a}} {\int }_{- ∞}^{+ ∞} x ( t ) {ψ}^{*} ( \frac{t - b}{a} ) d t \qquad ( 9 )$$

where ψ*(t) is the complex conjugate of the wavelet function ψ(t), a is the dilation parameter of the wavelet and b is the location parameter of the wavelet. The transform given by equation (9) may be used to construct a representation of a signal on a transform surface. The transform may be regarded as a time-scale representation. Wavelets are composed of a range of frequencies, one of which may be denoted as the characteristic frequency of the wavelet, where the characteristic frequency associated with the wavelet is inversely proportional to the scale a. One example of a characteristic frequency is the dominant frequency. Each scale of a particular wavelet may have a different characteristic frequency. The underlying mathematical detail required for the implementation within a time-scale can be found, for example, in Paul S. Addison. The Illustrated Wavelet Transform Handbook (Taylor & Francis Group 2002), which is hereby incorporated by reference herein in its entirety.

The continuous wavelet transform decomposes a signal using wavelets, which are generally highly localized in time. The continuous wavelet transform may provide a higher resolution relative to discrete transforms, thus providing the ability to garner more information from signals than typical frequency transforms such as Fourier transforms (or any other spectral techniques) or discrete wavelet transforms. Continuous wavelet transforms allow for the use of a range of wavelets with scales spanning the scales of interest of a signal such that small scale signal components correlate well with the smaller scale wavelets and thus manifest at high energies at smaller scales in the transform. Likewise, large scale signal components correlate well with the larger scale wavelets and thus manifest at high energies at larger scales in the transform. Thus, components at different scales may be separated and extracted in the wavelet transform domain. Moreover, the use of a continuous range of wavelets in scale and time position allows for a higher resolution transform than is possible relative to discrete techniques.

In addition, transforms and operations that convert a signal or any other type of data into a spectral (i.e., frequency) domain necessarily create a series of frequency transform values in a two-dimensional coordinate system where the two dimensions may be frequency and, for example, amplitude. For example, any type of Fourier transform would generate such a two-dimensional spectrum. In contrast, wavelet transforms, such as continuous wavelet transforms, are required to be defined in a three-dimensional coordinate system and generate a surface with dimensions of time, scale and, for example, amplitude. Hence, operations performed in a spectral domain cannot be performed in the wavelet domain; instead the wavelet surface must be transformed into a spectrum (i.e., by performing an inverse wavelet transform to convert the wavelet surface into the time domain and then performing a spectral transform from the time domain). Conversely, operations performed in the wavelet domain cannot be performed in the spectral domain; instead a spectrum must first be transformed into a wavelet surface (i.e., by performing an inverse spectral transform to convert the spectral domain into the time domain and then performing a wavelet transform from the time domain). Nor does a cross-section of the three-dimensional wavelet surface along, for example, a particular point in time equate to a frequency spectrum upon which spectral-based techniques may be used. At least because wavelet space includes a time dimension, spectral techniques and wavelet techniques are not interchangeable. It will be understood that converting a system that relies on spectral domain processing to one that relies on wavelet space processing would require significant and fundamental modifications to the system in order to accommodate the wavelet space processing (e.g., to derive a representative energy value for a signal or part of a signal requires integrating twice, across time and scale, in the wavelet domain while, conversely, one integration across frequency is required to derive a representative energy value from a spectral domain). As a further example, to reconstruct a temporal signal requires integrating twice, across time and scale, in the wavelet domain while, conversely, one integration across frequency is required to derive a temporal signal from a spectral domain. It is well known in the art that, in addition to or as an alternative to amplitude, parameters such as energy density, modulus, phase, among others may all be generated using such transforms and that these parameters have distinctly different contexts and meanings when defined in a two-dimensional frequency coordinate system rather than a three-dimensional wavelet coordinate system. For example, the phase of a Fourier system is calculated with respect to a single origin for all frequencies while the phase for a wavelet system is unfolded into two dimensions with respect to a wavelet's location (often in time) and scale.

The energy density function of the wavelet transform, the scalogram, is defined as

S(a, b)=|T(a,b)|² (10)

where ‘∥’ is the modulus operator. The scalogram may be resealed for useful purposes. One common resealing is defined as

$${S}_{R} ( a , b ) = \frac{{\vert T ( a , b ) \vert}^{2}}{a} \qquad ( 11 )$$

and is useful for defining ridges in wavelet space when, for example, the Morlet wavelet is used. Ridges are defined as the locus of points of local maxima in the plane. Any reasonable definition of a ridge may be employed in the method. Also included as a definition of a ridge herein are paths displaced from the locus of the local maxima. A ridge associated with only the locus of points of local maxima in the plane are labeled a “maxima ridge”.

For implementations requiring fast numerical computation, the wavelet transform may be expressed as an approximation using Fourier transforms. Pursuant to the convolution theorem, because the wavelet transform is the cross-correlation of the signal with the wavelet function, the wavelet transform may be approximated in terms of an inverse FFT of the product of the Fourier transform of the signal and the Fourier transform of the wavelet for each required a scale and then multiplying the result by \sqrt{a}.

In the discussion of the technology which follows herein, the “scalogram” may be taken to include all suitable forms of resealing including, but not limited to, the original unsealed wavelet representation, linear resealing, any power of the modulus of the wavelet transform, or any other suitable resealing. In addition, for purposes of clarity and conciseness, the term “scalogram” shall be taken to mean the wavelet transform, T(a,b) itself, or any part thereof For example, the real part of the wavelet transform, the imaginary part of the wavelet transform, the phase of the wavelet transform, any other suitable part of the wavelet transform, or any combination thereof is intended to be conveyed by the term “scalogram”.

A scale, which may be interpreted as a representative temporal period, may be converted to a characteristic frequency of the wavelet function. The characteristic frequency associated with a wavelet of arbitrary a scale is given by

$$f = \frac{{f}_{c}}{a} \qquad ( 12 )$$

where f_{c}, the characteristic frequency of the mother wavelet (i.e., at a=1), becomes a scaling constant and f is the representative or characteristic frequency for the wavelet at arbitrary scale a.

Any suitable wavelet function may be used in connection with the present disclosure. One of the most commonly used complex wavelets, the Morlet wavelet, is defined as:

ψ(t)=π^{-1/4}(e^{i2πf}^{₀}^{t}−e^{-(2πf}^{₀}⁾^{^{2/2}})e^{-t}^{^{2/2}} (13)

where f₀ is the central frequency of the mother wavelet. The second term in the parenthesis is known as the correction term, as it corrects for the non-zero mean of the complex sinusoid within the Gaussian window. In practice, it becomes negligible for values of f₀>>0 and can be ignored, in which case, the Morlet wavelet can be written in a simpler form as

$$ψ ( t ) = \frac{1}{{π}^{1 / 4}} {e}^{i 2 π {f}_{0} t} {e}^{- {t}^{2} / 2} \qquad ( 14 )$$

This wavelet is a complex wave within a scaled Gaussian envelope. While both definitions of the Morlet wavelet are included herein, the function of equation (14) is not strictly a wavelet as it has a non-zero mean (i.e., the zero frequency term of its corresponding energy spectrum is non-zero). However, it will be recognized by those skilled in the art that equation (14) may be used in practice with f₀>>0 with minimal error and is included (as well as other similar near wavelet functions) in the definition of a wavelet herein. A more detailed overview of the underlying wavelet theory, including the definition of a wavelet function, can be found in the general literature. Discussed herein is how wavelet transform features may be extracted from the wavelet decomposition of signals. For example, wavelet decomposition of PPG signals may be used to provide clinically useful information within a medical device.

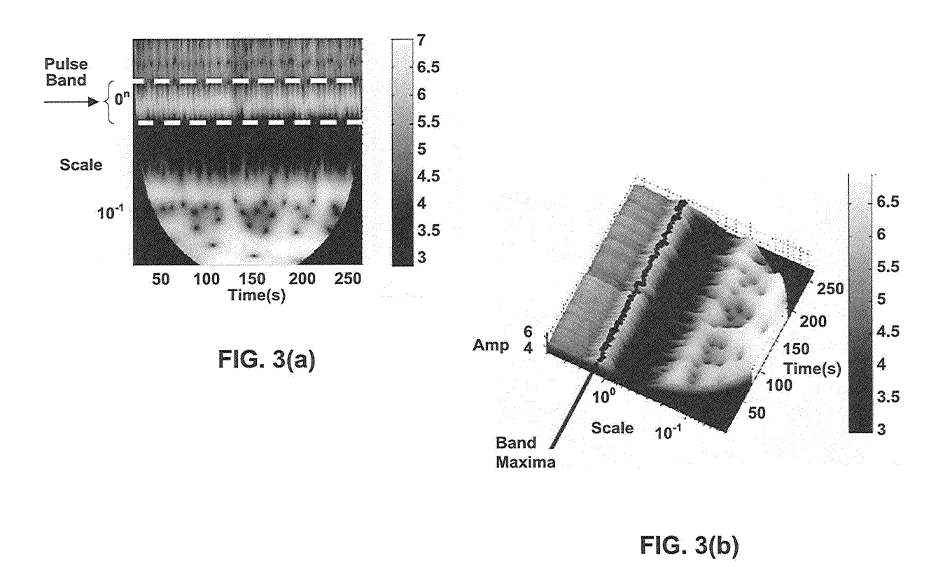

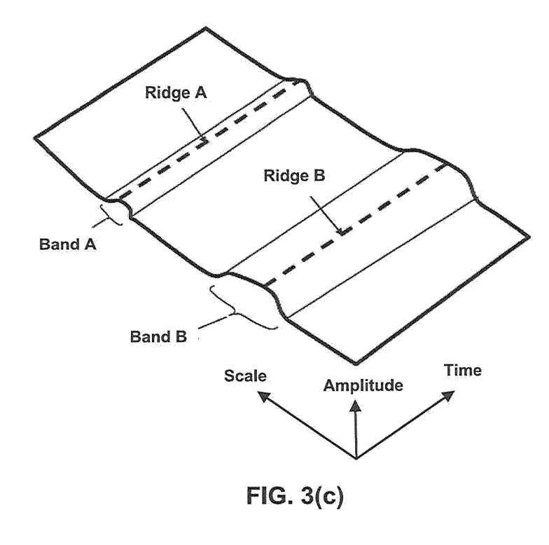

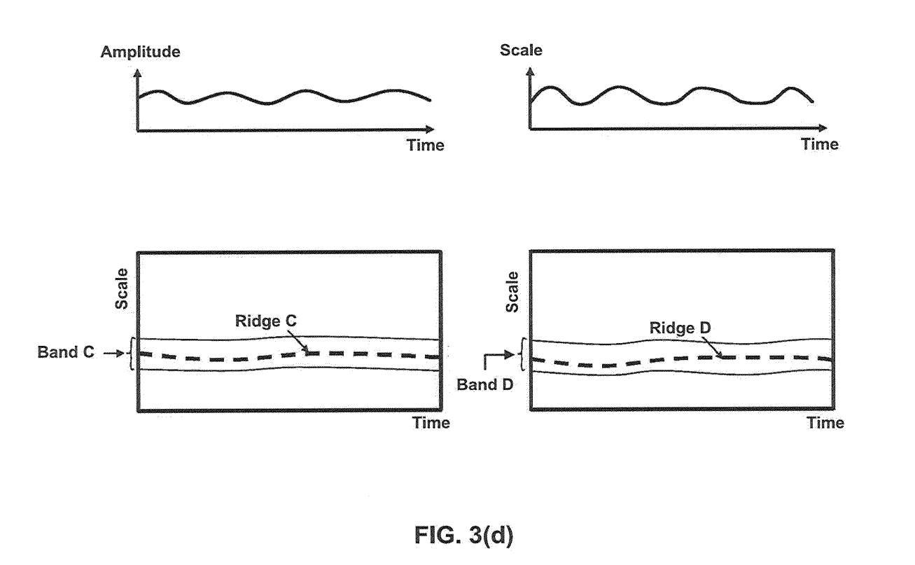

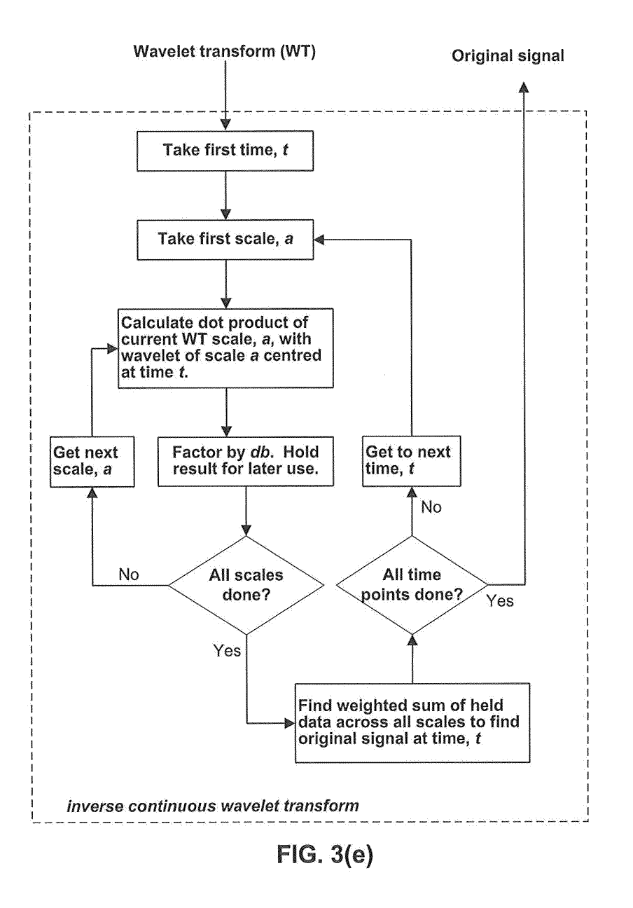

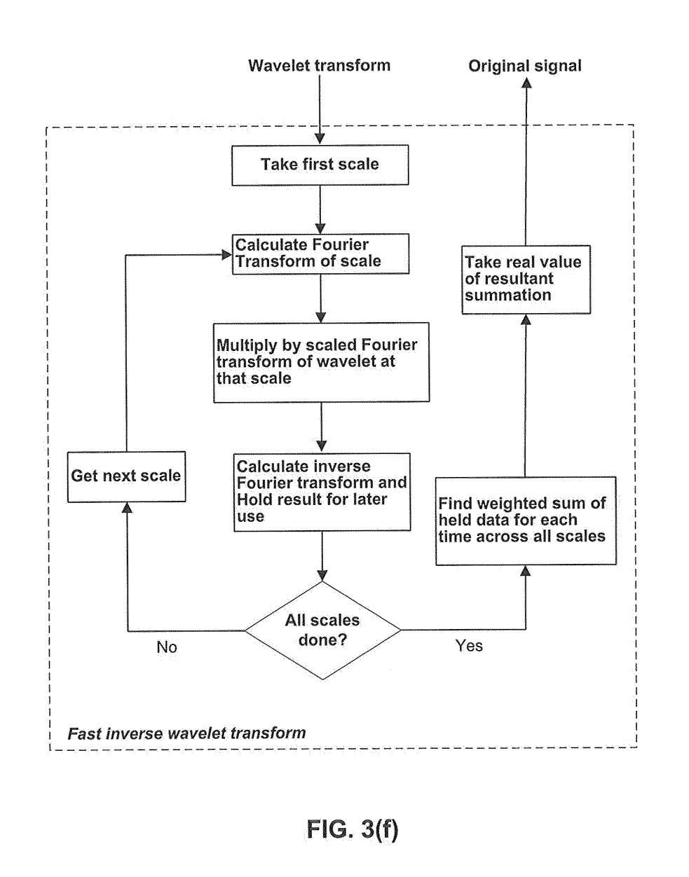

Pertinent repeating features in a signal give rise to a time-scale band in wavelet space or a resealed wavelet space. For example, the pulse component of a PPG signal produces a dominant band in wavelet space at or around the pulse frequency. FIGS. 3(a) and (b) show two views of an illustrative scalogram derived from a PPG signal, according to an embodiment. The figures show an example of the band caused by the pulse component in such a signal. The pulse band is located between the dashed lines in the plot of FIG. 3(a). The band is formed from a series of dominant coalescing features across the scalogram. This can be clearly seen as a raised band across the transform surface in FIG. 3(b) located within the region of scales indicated by the arrow in the plot (corresponding to 60 beats per minute). The maxima of this band with respect to scale is the ridge. The locus of the ridge is shown as a black curve on top of the band in FIG. 3(b). By employing a suitable resealing of the scalogram, such as that given in equation (11), the ridges found in wavelet space may be related to the instantaneous frequency of the signal. In this way, the pulse rate may be obtained from the PPG signal. Instead of resealing the scalogram, a suitable predefined relationship between the scale obtained from the ridge on the wavelet surface and the actual pulse rate may also be used to determine the pulse rate.

By mapping the time-scale coordinates of the pulse ridge onto the wavelet phase information gained through the wavelet transform, individual pulses may be captured. In this way, both times between individual pulses and the timing of components within each pulse may be monitored and used to detect heart beat anomalies, measure arterial system compliance, or perform any other suitable calculations or diagnostics. Alternative definitions of a ridge may be employed. Alternative relationships between the ridge and the pulse frequency of occurrence may be employed.

As discussed above, pertinent repeating features in the signal give rise to a time-scale band in wavelet space or a resealed wavelet space. For a periodic signal, this band remains at a constant scale in the time-scale plane. For many real signals, especially biological signals, the band may be non-stationary; varying in scale, amplitude, or both over time. FIG. 3(c) shows an illustrative schematic of a wavelet transform of a signal containing two pertinent components leading to two bands in the transform space, according to an embodiment. These bands are labeled band A and band B on the three-dimensional schematic of the wavelet surface. In this embodiment, the band ridge is defined as the locus of the peak values of these bands with respect to scale. For purposes of discussion, it may be assumed that band B contains the signal information of interest. This will be referred to as the “primary band”. In addition, it may be assumed that the system from which the signal originates, and from which the transform is subsequently derived, exhibits some form of coupling between the signal components in band A and band B. When noise or other erroneous features are present in the signal with similar spectral characteristics of the features of band B then the information within band B can become ambiguous (i.e., obscured, fragmented or missing). In this case, the ridge of band A may be followed in wavelet space and extracted either as an amplitude signal or a scale signal which will be referred to as the “ridge amplitude perturbation” (RAP) signal and the “ridge scale perturbation” (RSP) signal, respectively. The RAP and RSP signals may be extracted by projecting the ridge onto the time-amplitude or time-scale planes, respectively. The top plots of FIG. 3(d) show a schematic of the RAP and RSP signals associated with ridge A in FIG. 3(c). Below these RAP and RSP signals are schematics of a further wavelet decomposition of these newly derived signals. This secondary wavelet decomposition allows for information in the region of band B in FIG. 3(c) to be made available as band C and band D. The ridges of bands C and D may serve as instantaneous time-scale characteristic measures of the signal components causing bands C and D. This technique, which will be referred to herein as secondary wavelet feature decoupling (SWFD), may allow information concerning the nature of the signal components associated with the underlying physical process causing the primary band B (FIG. 3(c)) to be extracted when band B itself is obscured in the presence of noise or other erroneous signal features.

In some instances, an inverse continuous wavelet transform may be desired, such as when modifications to a scalogram (or modifications to the coefficients of a transformed signal) have been made in order to, for example, remove artifacts. In one embodiment, there is an inverse continuous wavelet transform which allows the original signal to be recovered from its wavelet transform by integrating over all scales and locations, a and b:

$$x ( t ) = \frac{1}{{C}_{g}} {\int }_{- ∞}^{∞} {\int }_{0}^{∞} T ( a , b ) \frac{1}{\sqrt{a}} ψ ( \frac{t - b}{a} ) \frac{d a d b}{{a}^{2}} \qquad ( 15 )$$

which may also be written as:

$$x ( t ) = \frac{1}{{C}_{g}} {\int }_{- ∞}^{∞} {\int }_{0}^{∞} T ( a , b ) {ψ}_{a , b} ( t ) \frac{d a d b}{{a}^{2}} \qquad ( 16 )$$

where C_{g} is a scalar value known as the admissibility constant. It is wavelet type dependent and may be calculated from:

$${C}_{g} = {\int }_{0}^{∞} \frac{{\vert \hat{ψ} ( f ) \vert}^{2}}{f} d f \qquad ( 17 )$$

FIG. 3(e) is a flow chart of illustrative steps that may be taken to perform an inverse continuous wavelet transform in accordance with the above discussion. An approximation to the inverse transform may be made by considering equation (15) to be a series of convolutions across scales. It shall be understood that there is no complex conjugate here, unlike for the cross correlations of the forward transform. As well as integrating over all of a and b for each time t, this equation may also take advantage of the convolution theorem which allows the inverse wavelet transform to be executed using a series of multiplications. FIG. 3(f) is a flow chart of illustrative steps that may be taken to perform an approximation of an inverse continuous wavelet transform. It will be understood that any other suitable technique for performing an inverse continuous wavelet transform may be used in accordance with the present disclosure.

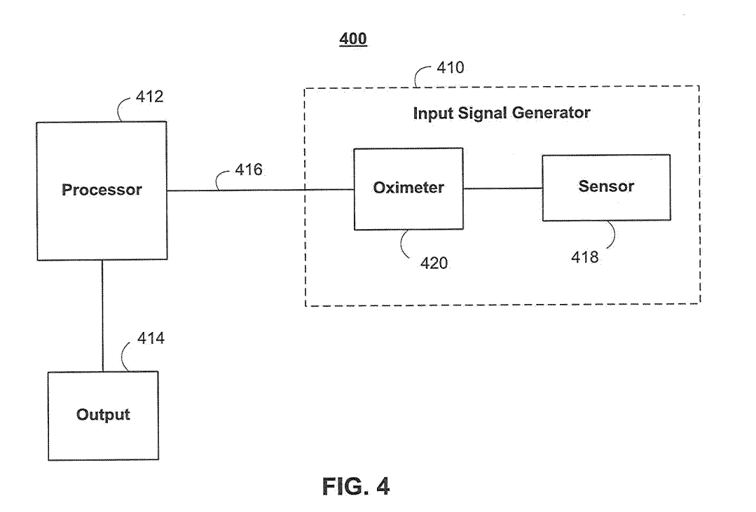

FIG. 4 is an illustrative continuous wavelet processing system in accordance with an embodiment. In this embodiment, input signal generator 410 generates an input signal 416. As illustrated, input signal generator 410 may include oximeter 420 coupled to sensor 418, which may provide as input signal 416, a PPG signal. It will be understood that input signal generator 410 may include any suitable signal source, signal generating data, signal generating equipment, or any combination thereof to produce signal 416. Signal 416 may be any suitable signal or signals, such as, for example, biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In this embodiment, signal 416 may be coupled to processor 412. Processor 412 may be any suitable software, firmware, and/or hardware, and/or combinations thereof for processing signal 416. For example, processor 412 may include one or more hardware processors (e.g., integrated circuits), one or more software modules, computer-readable media such as memory, firmware, or any combination thereof. Processor 412 may, for example, be a computer or may be one or more chips (i.e., integrated circuits). Processor 412 may perform the calculations associated with the continuous wavelet transforms of the present disclosure as well as the calculations associated with any suitable interrogations of the transforms. Processor 412 may perform any suitable signal processing of signal 416 to filter signal 416, such as any suitable band-pass filtering, adaptive filtering, closed-loop filtering, and/or any other suitable filtering, and/or any combination thereof.

Processor 412 may be coupled to one or more memory devices (not shown) or incorporate one or more memory devices such as any suitable volatile memory device (e.g., RAM, registers, etc.), non-volatile memory device (e.g., ROM, EPROM, magnetic storage device, optical storage device, flash memory, etc.), or both, The memory may be used by processor 412 to, for example, store data corresponding to a continuous wavelet transform of input signal 416, such as data representing a scalogram. In one embodiment, data representing a scalogram may be stored in RAM or memory internal to processor 412 as any suitable three-dimensional data structure such as a three-dimensional array that represents the scalogram as energy levels in a time-scale plane. Any other suitable data structure may be used to store data representing a scalogram.

Processor 412 may be coupled to output 414. Output 414 may be any suitable output device such as, for example, one or more medical devices (e.g., a medical monitor that displays various physiological parameters, a medical alarm, or any other suitable medical device that either displays physiological parameters or uses the output of processor 412 as an input), one or more display devices (e.g., monitor, PDA, mobile phone, any other suitable display device, or any combination thereof), one or more audio devices, one or more memory devices (e.g., hard disk drive, flash memory, RAM, optical disk, any other suitable memory device, or any combination thereof), one or more printing devices, any other suitable output device, or any combination thereof.

It will be understood that system 400 may be incorporated into system 10 (FIGS. 1 and 2) in which, for example, input signal generator 410 may be implemented as parts of sensor 12 and monitor 14 and processor 412 may be implemented as part of monitor 14.

In some embodiments, instead of computing the scalogram using the wavelet transform and, for example, associated wavelet convolutions, the wavelet transform may be estimated using a Goertzel technique. In particular, computing the scalogram using the wavelet transform may require complex computationally intensive operations including convolution operations. These complex operations involved in computing the transform may be reduced to simple multiplication, addition and/or subtraction operations with the Goertzel technique. In some implementations, the Goertzel technique may be used to produce complex outputs and estimate a Complex Morlet wavelet transform or any other suitable type of wavelet transform. In some implementations, the Goertzel technique may be used to produce only magnitude squared values (e.g., when phase information is not required). In such implementations, the magnitude squared values may correspond to a Gaussian envelope and thus it may not be necessary to perform a square root operation on the magnitude squared values.

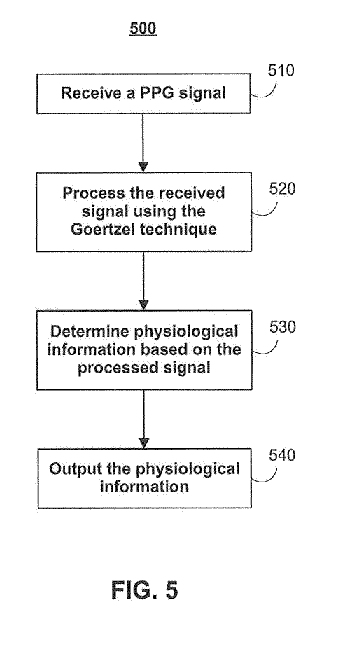

FIG. 5 shows an illustrative flow diagram 500 for employing the Goertzel technique on a received signal in accordance with an embodiment. At step 510, a signal, such as a PPG signal, is received. For example, a microprocessor 48 may be coupled to a patient monitor 14 (FIGS. 1 and 2). Microprocessor 48 may receive a signal from patient monitor 14. In some implementations, microprocessor 48 may receive as the input signal a PPG signal that has been preprocessed by other functions or any other intermediate data. Microprocessor 48 may perform the Goertzel technique on the preprocessed input data or other intermediate data.

At step 520, the received signal is processed using the Goertzel technique (discussed in further detail below). For example, microprocessor 48 may perform the Goertzel technique on the received signal to generate a scalogram that estimates a Wavelet transform (e.g., generated with a Complex Morlet, Mexican Hat or other suitable wavelet). In particular, microprocessor 48 may compute a plurality of magnitude values for each sample in at least one scale. Microprocessor 48 may store the computed magnitude values in ROM 52 or RAM 54 (FIG. 2). In some implementations, microprocessor 48 may compute and store coefficient values for each of the at least one scale in ROM 52 or RAM 54 before computing the magnitude values. Microprocessor 48 may compute the magnitude values in fixed or floating point format based on the level of accuracy needed in the output scalogram.

In some implementations, microprocessor 48 may change the width of the filter response represented by the magnitude values by windowing the input samples (i.e., the input data). For example, microprocessor 48 may multiply the input samples by a set of pre-defined values to reduce or increase the number of data samples. In particular, microprocessor 48 may apply a Hamming or Hanning window on the input data to change the width of the filter response.

In some embodiments, microprocessor 48 may determine whether the computed magnitude values are skewed in time. When the magnitude values are skewed in time, microprocessor 48 may perform one or more de-skewing techniques to correct the scalogram. In some implementations, microprocessor 48 may perform the de-skewing techniques when the input data samples are received and processed in real-time. In some implementations, this step may be skipped when the input data samples or a portion of the input data samples are retrieved from ROM 52 or RAM 54 or some other source of internal or external storage (e.g., batch processing).

At step 530, physiological information is determined based on the processed signal. The physiological information may be include, for example, SpO2, pulse rate, breathing rate or information, and/or other physical status information of a patient. For example, microprocessor 48 may analyze peaks and troughs of the computed magnitude values. Microprocessor 48 may derive the physiological information based on the computed magnitude values and various heuristics.

At step 540, the physiological information may be output. For example, microprocessor 48 may output the physiological information to ROM 52 or RAM 54 for storage or another system component for further processing. In some implementations, microprocessor 48 may generate a display based on the physiological information for output to display 28. In some embodiments, the processor may generate a graphical representation (e.g., 3D model) of the magnitude values for output to display 28 allowing a user to determine physiological information from the graphical representation.

After the coefficient value is computed for each scale, a pair of temporary storage values are initialized to zero. The temporary storage values are used in computing the magnitude values for each sample in each scale.

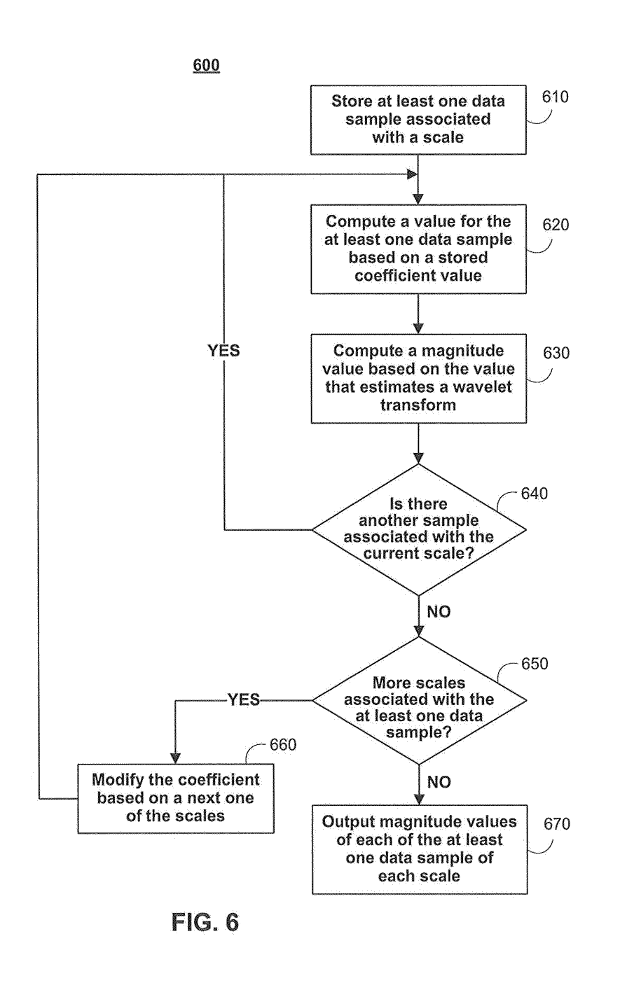

FIG. 6 shows an illustrative flow diagram 600 for estimating the wavelet transform using the Goertzel technique in accordance with an embodiment. At step 610, at least one data sample associated with at least one scale is stored. For example, as discussed in relation to step 510, microprocessor 48 may receive a signal (e.g., PPG signal) and process the signal to generate and store at least one data sample in ROM 52 or RAM 54. In some implementations, microprocessor 48 may apply a window function to the stored at least one data sample to change the width of the filter response produced with the Goertzel technique. For example, microprocessor 48 may multiply the stored at least one data sample by a set of pre-defined values (e.g., a window) that correspond to Hamming, Gaussian or Hanning windows. Any other suitable window may be applied. Microprocessor 48 may select which window is most appropriate to apply to the at least one data sample based, for example, at least in part on the desired or necessary resolution between the scales.

At step 620, a Q0 value may be computed for the at least one data sample in the at least one scale based on a coefficient value. The coefficient value may be computed and stored for each scale in the scalogram before the magnitude and Q0 values of the samples in a particular scale are computed. In some implementations, the coefficient values for each scale are computed based on an initial set of predetermined values in accordance with Equation (1) below:

k=integer (0.5+N*target_freq/sample_rate);

w=2*pi*k/N
sine=sin(w);
cosine=cosine(w); and
coefficient=2*cosine
   where N is the block size which controls the scale resolution, target_freq is the particular scale being used, pi is the predefined constant of about 3.14, and sample rate is a known predetermined value, usually the rate at which the data to be processed was sampled at.

In some embodiments, microprocessor 48 may retrieve from ROM 52 or RAM 54 the previously computed coefficient value that is associated with the scale being processed. In some implementations, microprocessor 48 may compute the coefficient value based on Equation (1) each time the magnitude value for the at least one data sample in a particular scale is computed to reduce memory requirements.

The Q0 value may be computed in accordance with Equation (2) below:

Q0=coefficient*Q1−Q2+sample

where Q0 is the value, Q1 and Q2 are temporary storage values, coefficient is the coefficient computed or retrieved from ROM 52 or RAM 54 or some other suitable storage device for the scale being processed and sample is the data sample of the received signal.

After the Q0 value is computed at step 620, a pair of temporary storage values are updated for the next iteration (e.g., for the next sample or scale) and at step 630 a magnitude value is computed for the sample in the scale being processed. For example, the temporary storage values may be updated by setting Q2=Q1 and Q1=Q0. In particular, the temporary storage value Q2 is assigned the current value of temporary storage value Q1 and Q1 is assigned the computed value Q0.

The magnitude value may estimate a Wavelet transform or a portion of the Wavelet transform. The magnitude value may be computed in accordance with Equation (3) below:

magnitude_{—}sq=Q1*Q1+Q2*Q2−Q1*Q2*coefficient

where magnitude_sq is the magnitude value in squared form, and Q1, Q2 and coefficient are the values discussed above. In some implementations, to compute the magnitude value at step 630, the processor may compute the sum of the squares of real and imaginary values. In particular, the magnitude value may be computed in accordance with Equation (4) below:

real=(Q1−Q2*cosine);

imaginary=(Q2*sine);

magnitude_sq=real²+imaginary²

where cosine and sine are the values discussed above that may be pre-computed to determine the coefficient value of the scale being processed. Computing the magnitude value in accordance with the latter equation, preserves the phase information which may be further used to determine physiological information as discussed in relation to step 530. The magnitude value may be stored in the memory and the process proceeds to step 640. The real and imaginary value based approach may be suitable in implementations where a complex scalogram is needed for example, for phase estimation purposes.

At step 640, a determination is made as to whether there is another sample associated with the current scale being processed. For example, microprocessor 48 may receive a value representing the total number of data samples that are associated with the scale. As each magnitude value is computed for each sample, microprocessor 48 may increment a counter to advance to the next sample. When the counter value has not reached the value representing the total number of samples, microprocessor 48 may determine that there is another sample associated with the current scale and may proceed to step 620 to compute the Q0 value and magnitude value for the next sample. Otherwise, the process proceeds to step 650.

At step 650, a determination is made as to whether there is more scales associated with the at least one data sample. In particular, after all the samples associated with a particular scale have been processed to compute the magnitude value, microprocessor 48 may compute the magnitude values for the data samples in another scale. For example, microprocessor 48 may receive a value representing the total number of scales that are associated with the data samples. After each set of magnitude values are computed for each of the samples in a particular scale, microprocessor 48 may increment a counter to advance to the next scale. When the counter value has not reached the value representing the total number of scales, microprocessor 48 may determine that there is another scale associated with the data samples and may proceed to step 660. Otherwise, the process proceeds to step 670.

At step 660, the coefficients are modified based on the next one of the scales. For example, microprocessor 48 may retrieve the coefficient values that correspond to the next scale from ROM 52 or RAM 54. In particular, when the coefficient values for each scale are pre-computed in accordance with Equation (1) and stored in ROM 52 or RAM 54, microprocessor 48 may retrieve the coefficient values as they become necessary in computing the magnitude values. Alternatively or in addition, microprocessor 48 may compute the new coefficient value based on the next scale. In particular, microprocessor 48 may compute the new coefficient value in accordance with Equation (1) discussed above where the parameter N determines the scale resolution (i.e., how wide or narrow/selective the scale is) and the parameter target_freq determines the scale being used. In some implementations, the shape of the wavelet may be changed by modifying the values of any combination of the precomputed coefficient values, Q0, Q1 and Q2 values (feedback coefficients) and/or adding more feedback with appropriate coefficients.

At step 670, the magnitude values of each of the at least one sample in each scale are output. For example, microprocessor 48 may output the magnitude values for each data sample in each of the at least one scale to ROM 52 or RAM 54 for storage or another system component for further processing. In some implementations, microprocessor 48 may generate a display based on the computed magnitude values for output to a display 28. In some embodiments, microprocessor 48 may generate a graphical representation (e.g., a scalogram surface) of the magnitude values for output to display 28 allowing a user to, for example, determine physiological information from the graphical representation. In particular, microprocessor 48 may estimate a wavelet transform based at least in part on the magnitude values. The estimated wavelet transform may be used to generate a scalogram which may be processed to derive, for example, physiological information.

In some embodiments, intermediate processing may be performed at any one of steps 630, 660 and/or 670. In particular, the intermediate processing may include performing de-skewing operations in a similar manner as discussed above. For example, microprocessor 48 may determine that the magnitude values computed at step 630 or 670 are skewed in time. Accordingly, microprocessor 48 may apply a de-skewing technique to correct the results.

In some implementations, the window discussed in relation to step 610 may be applied after step 670 when all of the magnitude values have been computed. For example, after step 670, microprocessor 48 may compare the computed magnitude values (or a graphical representation associated with the computed magnitude values) with known values or graphical representation representing the received at least one sample based on a particular wavelet (e.g., Complex Morlet or Mexican Hat). When the comparison exceeds a predetermined threshold (e.g., more than 10% deviation), microprocessor 48 may repeat the process of all or a portion of flow diagram 600 using a different window function for the stored at least one sample.

In some embodiments, instead of computing each magnitude value for scale sequentially, the Goertzel technique may be used to compute the magnitude values that estimate a Wavelet Transform in parallel. In particular, additional circuitry or processes may be generated or run to compute the corresponding magnitude values of each scale separately in parallel.

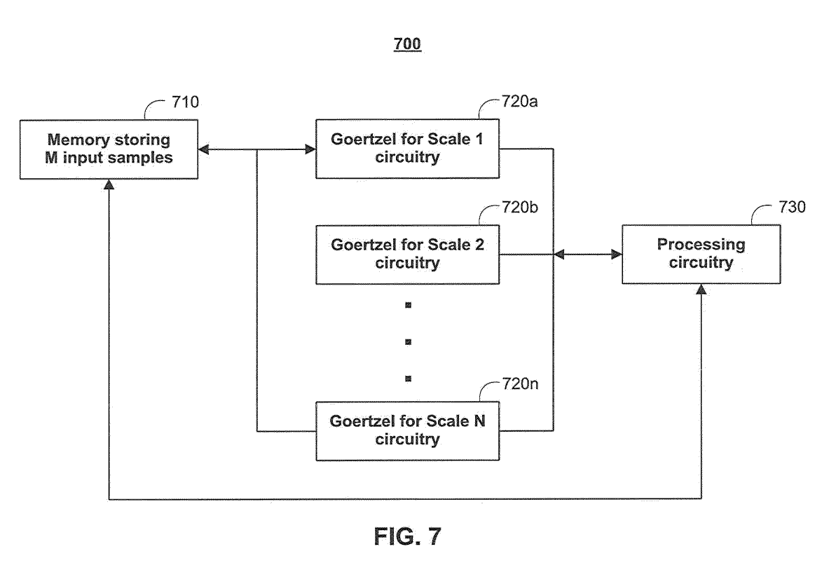

FIG. 7 is a block diagram of a system 700 implementing the Goertzel technique in parallel in accordance with an embodiment. System 700 includes a memory 710, Goertzel computation circuitries 720a-n and processing circuitry 730. Processing circuitry 730 may store in memory 710 data samples of a received signal (e.g., a PPG signal). The data samples may be provided by memory 710 to each Goertzel computation circuitry 720a-n. Processing circuitry 730 may be the same or similar as microprocessor 48 (FIG. 2). Also, memory 710 may be the same or similar as RAM 52 or ROM 54.

Each Goertzel computation circuitry 720a-n may pre-compute or have stored coefficient values for the Goertzel algorithm corresponding to respective scales 1-N. In particular, Goertzel computation circuitry 720a may compute first coefficient values for a first scale based on Equation (1) above and Goertzel computation circuitry 720b may compute second coefficient values for a second scale based on Equation (1) above. The computed coefficient values may be stored in memory 710 or in a memory local to each of Goertzel computation circuitry 720a-n.

Each Goertzel computation circuitry 720a-n may compute a magnitude value for each of the samples received from memory 710 based on the coefficients associated with the scale corresponding to the respective Goertzel computation circuitry 720a-n. For example, each Goertzel computation circuitry 720a-n may perform the operations discussed above in relation to steps 620, 630 and 640 (FIG. 6). More specifically, each Goertzel computation circuitry 720a-n may implement either Equation (3) or (4) above to output the magnitude values for each sample in each scale.

In some implementations, a first Goertzel computation circuitry 720a may compute the magnitude values for each sample in a first scale using Equation (3) while a second Goertzel computation circuitry 720b may compute the complex magnitude values for each sample in a second scale using Equation (4). The result is that a first portion of the magnitude values in a first set of scales (e.g., half of the total scales) is provided in complex form (e.g., with phase information) while a second portion of the magnitude values in a second set of scales (e.g., the other half of the total scales) is provided more quickly without the phase information.

Goertzel computation circuitries 720a-n may operate in a synchronous or asynchronous manner. When Goertzel computation circuitries 720a-n operate synchronously, each Goertzel computation circuitry 720a-n may output a magnitude value corresponding to the respective scale at substantially the same time (e.g., on the same clock tic). When Goertzel computation circuitries 720a-n operate asynchronously, each Goertzel computation circuitry 720a-n may output a magnitude value corresponding to the respective scale whenever the circuitry completes the computation. In such circumstances, processing circuitry 730 may be required to wait one or more clock cycles before computing the estimate for the Wavelet Transform from the magnitude values. Although Goertzel computation circuitries 720a-n are shown and described as being implemented in hardware, it should be understood that each Goertzel computation circuitry 720a-n may represent a separate process that may run on a multi-processor or multi-core processing system. Alternatively, each Goertzel computation circuitry 720a-n may represent a separate process that may run on a time shared basis using the same computation circuit (e.g., central processing unit).

Processing circuitry 730 may receive the magnitude values computed by each Goertzel computation circuitry 720a-n. Processing circuitry 730 may correct for skew in the output magnitude values by performing a de-skewing technique. In some implementations, processing circuitry 730 may perform a window function (discussed above) on the data samples stored in memory 710 before Goertzel computation circuitries 720a-n compute the magnitude values. Processing circuitry 730 may output the magnitude values for each data sample in each of the at least one scale to memory 710 for storage or another system component for further processing. In some implementations, processing circuitry 730 may generate a display based on the computed magnitude values for output to a display screen (not shown). In some embodiments, processing circuitry 730 may generate a graphical representation (e.g., 3D model) of the magnitude values for output to a display allowing a user to determine physiological information of a patient from the graphical representation.

Although the Goertzel process (technique) is shown and described as an iterative process, it should be understood that in some implementations, the Goertzel process may be implemented in a recursive manner.

It should be understood that the above steps of the flow diagram of FIGS. 5 and 6 may be executed or performed in any order or sequence not limited to the order and sequence shown and described in the figure. Also, some of the above steps of the flow diagram of FIGS. 5 and 6 may be executed or performed substantially simultaneously where appropriate or in parallel to reduce latency and processing times.

The above described embodiments of the present disclosure are presented for purposes of illustration and not of limitation, and the present disclosure is limited only by the claims which follow.

What is claimed is:

1. A method for processing a signal by estimating a wavelet transform of the signal using at least one scale, the at least one scale being associated with at least one data sample, the method comprising:
generating, using electronic processing equipment, a magnitude value for each sample in each of the at least one scale based at least in part on a Goertzel technique, wherein each magnitude value estimates a wavelet transform; and
storing, in an electronic storage device, the generated magnitude values.

2. The method of claim 1, wherein the generating comprises:
initializing a predetermined coefficient value and temporary storage values for each sample in each of the at least one scale;
for each of the at least one data sample in each of the at least one scale:
computing a recursion value based on a first function of the temporary storage values corresponding to the at least one data sample in each of the at least one scale, the predetermined coefficient value, and the corresponding at least one data sample in each of the at least one scale; and
updating the temporary storage values corresponding to the at least one data sample in each of the at least one scale based on the computed recursion value;
repeating the computing and the updating a predetermined number of times; and
computing the magnitude value for each of the at least one data samples in each of the at least one scale based on a second function of (1) the predetermined coefficient value and (2) the updated temporary storage values corresponding to the at least one data sample in each of the at least one scale.

3. The method of claim 2, wherein:
an output of the first function is computed in accordance with:
coeff*Q1−Q2+sample;
where coeff is the predetermined coefficient value, Q1 and Q2 are first and second of the temporary values and sample is the corresponding at least one sample in each of the at least one scale; and
an output of the second function is computed in accordance with:
Q1*Q1−Q2*Q2−Q1*Q2*coeff.

4. The method of claim 3, wherein:
the predetermined coefficient value is computed as a multiple of the cosine function of a value corresponding the predetermined number of times, a sample rate of the at least one scale, and a target frequency value for the at least one scale.

5. The method of claim 2 wherein the predetermined number of times corresponds to a number of scales in the wavelet transform.

6. The method of claim 1 further comprising providing the magnitude values of each of the at least one data sample in each of the at least one scale as the estimated wavelet transform scalogram.

7. The method of claim 1, wherein the magnitude values for each of the at least one data sample in each of the at least one scale are computed in parallel.

8. The method of claim 1, wherein the magnitude values are computed without convolution operations.

9. The method of claim 1 further comprising applying a window to the at least one data sample in each of the at least one scale to change the filter response of the at least one scale.

10. The method of claim 9, wherein the window is a Gaussian window or a Hamming window.

11. A system for processing a signal by estimating a wavelet transform of the signal using at least one scale, the at least one scale being associated with at least one data sample, the system comprising:
an electronic storage device; and
processing circuitry configured to:
generate, using electronic processing equipment, a magnitude value for each sample in each of the at least one scale based at least in part on a Goertzel technique, wherein each magnitude value estimates a wavelet transform; and
store, in the electronic storage device, the generated magnitude values.

12. The system of claim 11, wherein the processing circuitry is further configured to:
initialize a predetermined coefficient value and temporary storage values for each sample in each of the at least one scale;
for each of the at least one data sample in each of the at least one scale:
compute a recursion value based on a first function of the temporary storage values corresponding to the at least one data sample in each of the at least one scale, the predetermined coefficient value, and the corresponding at least one data sample in each of the at least one scale; and
update the temporary storage values corresponding to the at least one data sample in each of the at least one scale based on the computed recursion value;
repeat the computing and the updating a predetermined number of times; and
compute the magnitude value for each of the at least one data samples in each of the at least one scale based on a second function of (1) the predetermined coefficient value and (2) the updated temporary storage values corresponding to the at least one data sample in each of the at least one scale.

13. The system of claim 12, wherein:
an output of the first function is computed in accordance with:
coeff*Q1−Q2+sample;
where coeff is the predetermined coefficient value, Q1 and Q2 are first and second of the temporary values and sample is the corresponding at least one sample in each of the at least one scale; and
an output of the second function is computed in accordance with:
Q1*Q1+Q2*Q2−Q1*Q2*coeff.

14. The system of claim 13, wherein:
the predetermined coefficient value is computed as a multiple of the cosine function of a value corresponding the predetermined number of times, a sample rate of the at least one scale, and a target frequency value for the at least one scale.

15. The system of claim 12 wherein the predetermined number of times corresponds to a number of scales in the wavelet transform.

16. The system of claim 11 wherein the processing circuitry is further configured to provide the magnitude values of each of the at least one data sample in each of the at least one scale as the estimated wavelet transform scalogram.

17. The system of claim 11, wherein the magnitude values for each of the at least one data sample in each of the at least one scale are computed in parallel.

18. The system of claim 11, wherein the magnitude values are computed without convolution operations.

19. The system of claim 11 further comprising applying a window to the at least one data sample in each of the at least one scale to change the filter response of the at least one scale.

20. The system of claim 19, wherein the window is a Gaussian window or a Hamming window.
